(19) United States
(12) Patent Application Publication
(10) Pub. No.: US 2005/0095471 A1
(43) Pub. Date: May 5, 2005

(54) Method of operating a hybrid power system within a state of charge window

(76) Inventor: Vince Winstead, Farmington Hills, MI (US)

Correspondence Address: TUNG & ASSOCIATES, 838 WEST LONG LAKE, SUITE 120, BLOOMFIELD HILLS, MI, 48302, US

(21) Appl. No.: 10/700,973

(22) Filed: Nov. 4, 2003

(51) Int. Cl. H01M 8/04

(52) U.S. Cl. 429/13; 429/23

(57) ABSTRACT

A method of operating a hybrid fuel cell system within a state of charge window of a charge carrier such as a battery pack, improves system efficiency by reducing use of the fuel cell to charge the battery pack. Power is drawn in relative amounts from the fuel cell and the charge carrier based on a control strategy that considers the charge carrier's state of charge, overall load power requirements and the maximum power output capacity of the fuel cell.

### FIELD OF THE INVENTION

This invention generally relates to hybrid power systems employing fuel cells, and deals more particularly with a method of controlling system operation within a state-of-charge window of a battery pack in a manner that reduces use of the fuel cell.

### BACKGROUND OF THE INVENTION

Hybrid power systems employing multiple power energy sources require careful control of system components in order to coordinate the delivery of power from the sources to system loads. These loads can vary widely in magnitude, and occur unexpectedly in time, particularly in hybrid powered vehicles. Hybrid systems using fuel cells and battery packs as energy sources to power vehicles must be closely controlled to assure adequate reserve power is available under a variety of conditions, while also conserving fuel to maximize mileage.

In order to assure that adequate reserve power is present in the battery pack and that proper charging and discharging of the battery is maintained, the state-of-charge (SOC) of the battery is monitored, and charging and discharging are controlled so that the SOC remains within an acceptable range or “window”. When the SOC is low, the fuel cell may be called upon to produce power in order to charge the battery to keep the SOC within the desired window. The efficiency of the fuel cell in producing the powered needed to recharge the battery is dependant in part on the voltage region in which it is operating. Accordingly, the fuel cell may be called to recharge the battery under conditions in which the fuel cell is operating at less than maximum efficiency.

Accordingly, a need exists for a method of controlling the operation of a hybrid power system which maintains the SOC of the battery within a desired window, while minimizing the use of the fuel cell for battery charging.

### SUMMARY OF THE INVENTION

According to one aspect of the invention, a method is provided for controlling the operation of hybrid power system having a fuel cell and a charge carrier such as a battery pack. The method includes the steps of determining the state of charge of the charge carrier; setting the power output of the charge carrier to a first value if the power required by the load is less than the maximum power available to be supplied from the fuel cell; and, setting the power output of the charge carrier to a second value if the power required by the load is equal to or greater than the maximum power available to be supplied from the fuel cell.

According to another aspect of the invention, a method is provided for use in controlling the operation of a hybrid power system having a battery pack and a fuel cell, which maintains the battery pack's state-of-charge within a preselected range. The method includes the steps of monitoring the battery pack's state of charge; determining the amount of power required by the load; determining the amount of power being supplied by the fuel cell; and, setting the power output of the battery pack based on the determined amounts of power.

An important feature of the invention is that minimum use is made of the fuel cell to maintain the battery pack's SOC charge within a desired window. The control strategy shares the power sourced from the fuel cell and the battery pack to the load in a manner that optimizes the use of the fuel cell, thereby conserving fuel and lengthening the service life of the battery.

Another feature of the invention is that the power output of the battery pack is regulated based on load demand relative to the fuel cell's ability to satisfy this demand. By reducing the amount of power supplied to the load from the battery pack at certain times and using the fuel cell to satisfy any remaining portion of the demanded power, fuel cell use is optimized while maintaining the charge of the battery pack within a desired range.

These and other features and advantages of the present invention may be better understood by considering the following details of a description of a preferred embodiment of the invention. In the course of this description, reference will frequently be made to the attached drawings.

### BRIEF DESCRIPTION OF THE DRAWINGS

FIG. 1 is a block diagram of a hybrid fuel power system operated in accordance with the method of the invention;

FIG. 2 is a waveform diagram showing the lumped system load current in the system of FIG. 1 when operated in accordance with the method of the invention;

FIGS. 3a and 3b are waveform diagrams, respectively showing the voltage and current output of the fuel cell forming part of the system depicted in FIG. 1, based on calculated battery pack power;

FIG. 4 is a waveform diagram showing the power output of the fuel cell;

FIG. 5 is a waveform diagram showing the power output by a battery pack forming part of the charge carrier depicted in FIG. 1;

FIG. 6 is a waveform diagram showing the state of charge for the battery pack; and,

FIG. 7 is a flow chart showing the steps of the method of the present invention.

### DETAILED DESCRIPTION OF THE PREFERRED EMBODIMENT

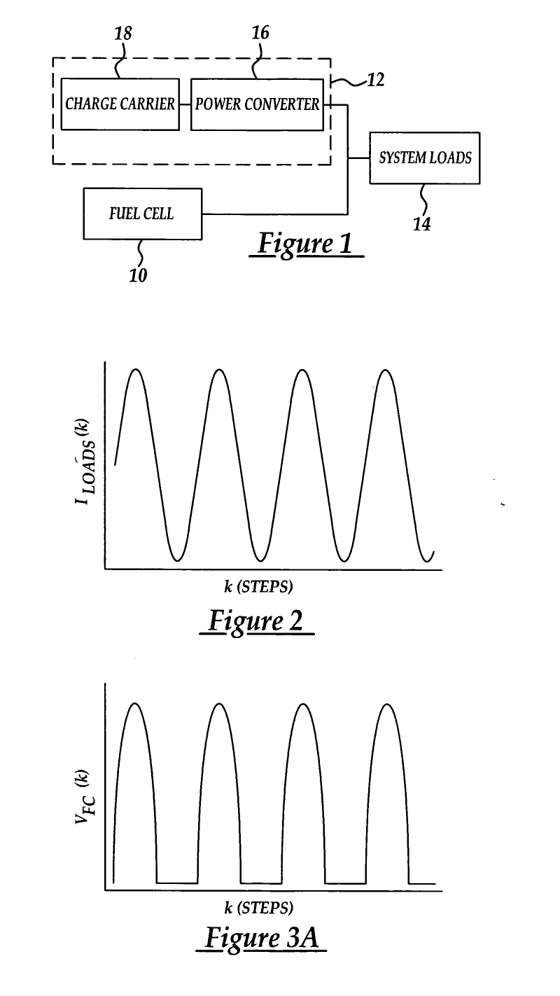

Referring first to FIG. 1, a fuel cell-based hybrid power system includes a fuel cell 10 and a d.c. power source 12 coupled in parallel with each other to supply power to system loads 14. The fuel cell 10 may be any of various types, such as a PEM (polymer electrolyte membrane), or a SOFC (solid oxide fuel cell) using any of a variety of fuels. These fuel cells are characterized by a voltage-current polarization curve (not shown), which dictates the operating regime of the fuel cell. This polarization curve shows an increasing power output as the fuel cell voltage is decreased to a maximum power boundary point after which the power output decreases with decreasing voltage. Another characteristic of these fuel cells is the approximately linear decrease in fuel conversion efficiency as the voltage is decreased. Thus, in order to operate the fuel cell efficiently, it would be desirable to maintain a lower threshold on the voltage: the maximum power boundary point. For purposes of this description, it is assumed the fuel cell 10 can be operated at any point along its polarization curve.

The d.c. energy source 12 includes a high voltage charge carrier 16 coupled in series with a power converter 18. The charge carrier 16 may include either a battery pack having a plurality of battery cells connected with each other, an ultracapacitor for storing electrical energy, a flywheel or other device for storing electrical power, or a combination of these devices. For illustration and sake of simplicity in explaining the invention herein, however, the charge carrier 16 will sometimes be referred to as a battery pack or battery. The power converter 18 is a conventional, bidirectional device that converts the power supplied by the charge carrier 16 into a form that is compatible with the requirements of the system loads 14. Specifically, the power converter converts the voltage and current supplied by the charge carrier 16 into levels that match the voltage on a parallel bus that supplies power to the system loads 14.

The system loads 14 may include a wide variety of devices that utilize electric power, which are coupled in parallel with the d.c. power source 12 and the fuel cell 10. For example, in the case of a vehicle application of the hybrid fuel power system, the system loads 14 may include wheel drive motors, motors driving vehicle accessories, regenerative braking devices, and other power using or power generating loads which have a negative (source or sink) or positive signed power. Similarly, the charge carrier 16 can have a negative (discharging) or positive (charging) sign.

The relative amount of power stored in the battery pack (charge carrier 16) is often referred to as its “state-of-charge” (SOC), i.e. the amount of stored energy expressed as a percentage of the battery pack's total ampere-hour capacity. In order to efficiently charge and discharge, the battery must be maintained within a charge range known as an SOC window that is adequate to meet the power requirements of the power system in which the battery is utilized. The power requirements of the system loads 14 are sourced either from the battery 16 or the fuel cell 10, depending on a variety of conditions, including the size of the load demand and the SOC of the battery. Typically, when the battery SOC drops to a threshold value at the lower end of the SOC window, the fuel cell 10 is activated to charge the battery until the battery SOC reaches a higher limit, near the upper end of the SOC window.

In accordance with the present invention, a method is provided for controlling the power sharing between the fuel cell 10 and the battery 16 sourced to the system loads 14 which optimizes the use of the fuel cell 10, and therefore reduces fuel consumption. The control strategy employed by the inventive method, in part, monitors the SOC of the charge carrier 16 and controls the power output by the charge carrier 16 based on the monitored SOC, and the system load demand.

In further explaining the control method of the present invention and its derivation, the flowing symbols and nomenclature will be used:
P_{FC}(k)=Fuel Cell Power
P_{FC}^{MAX}=Fuel Cell Maximum Power Output
V_{FC}(k)=Fuel Cell Voltage
I_{FC}(k)=Fuel Cell Current
V_{FC}^{MAX}=Fuel Cell Maximum Voltage
V_{FC}^{MIN}=Fuel Cell Minimum Voltage
V_{FC}^{MAX POWER}=Fuel Cell Voltage Maximum Power Point
P_{LOADS}(k)=Lumped System Loads Power
V_{LOADS}(k)=Lumped System Loads Voltage
I_{LOADS}(k)=Lumped System Loads Current
P_{CC}(k)=Charge Carrier Power
C(k)=Charge Carrier SOC
C_{NOM}=Charge Carrier Nominal SOC
C_{MIN}=Charge Carrier SOC Minimum
C_{MAX}=Charge Carrier SOC Maximum
S=SOC scaling constant
n_{PC}=Power Converter Efficiency
n_{CC}(k)=Charge Carrier Lumped Efficiency
e_{CC}=Charge Carrier Lumped Charge/Discharge Efficiency
n_{FC}(k)=Fuel Cell Efficiency
A=Fuel Cell polarization curve model constant
B=Fuel Cell polarization curve model constant
V_{O}=Voltage at which ohmic Region Linear Curve
Intercepts with Zero Current
S_{O}=Slope of the Ohmic Region Linear Curve

The control method is carried out by setting the charge carrier 16 power output, based on the previous SOC level, to the following
P_{CC}(k)=(n_{CC}(k)*V_{FC}^{MAX})/(2*S*V_{FC}(k))+C(k−1)−C_{NOM}
if the power required by the system loads 14 is less than the maximum power available from the fuel cell 10 and
P_{CC}(k)=−(P_{LOAD}(k)+P_{FC}^{MAX})
if the power required by the system loads 14 is equal to or greater than the maximum power available from the fuel cell 10 and the fuel cell is operating at its maximum power output. Simulation testing has shown that this control method considerably decreases the power supplied by the fuel cell 10 over time, when compared to the use of the charge carrier 16 only as an additional power source for fuel cell short falls, and as a sink for regenerative braking. This control strategy would therefore lead to a proportional increase in fuel economy.

A fuel cell polarization curve can be modeled as an exponential over the operating range of the fuel cell using two model constants A and B.
I_{FC}(k)=A*exp(−(V_{FC}²)/B) (1)
The constants can be found by fitting equation (1) with actual fuel cell polarization data using a variety of curve fitting methods. Fuel cell efficiency can also be modeled as a linear function of the fuel cell voltage.
n_{FC}(k)=V_{FC}(k)/V_{FC}^{MAX} (2)
It is assumed that Charge Carrier and Power Converter efficiencies are constant. The battery pack efficiency is set based on the signum of the charge carrier power.
N_{CC}(k)={(n_{PC}*e_{CC}); sgn(P_{CC}(k))≧0 {1/(n_{PC}*e_{CC}); otherwise
The power sharing relation between the different components of the system can be expressed as follows:
−P_{LOADS}(k)=P_{FC}(k)*n_{FC}(k)+P_{CC}(k)*n_{CC}(k)′ (3)
The control strategy sought is one that minimizes the power output from the fuel cell 10, which in turn minimizes the fuel used, while maintaining operation within a pre-defined charge carrier SOC window.
C(k)ε[C_{MIN}, C_{MAX}]
C(k)=C(k−1)−P_{CC}(k) (4)
Equation (3) can be rewritten as a function of the fuel cell power.
P_{FC}(k)=−(1/n_{FC}(k))*(P_{LOADS}(k)+P_{CC}(k)*n_{FC}(k)) (5)

Given the constraints previously mentioned, it is desirable to optimize the choice of P_{CC}(k). Thus, a minimization problem is set up incorporating the SOC constraint explicitly.
Min P_{CC}(k) {[31 (1/n_{FC}(k))*(P_{LOADS}(k)+P_{CC}(k)*n_{CC}(k))]+S*[C(k)−C_{NOM}]²} (6)
A constant, S, is used to define the strength of the constraint and to indirectly set the boundaries of the SOC window. The constraint encourages the choice of P_{CC}(k) to balance keeping the output of the fuel cell small as well as keeping the SOC close to the nominal SOC. From equation, it follows that:
(C(k))²=(C(k−1))²−2*C(k)*P_{CC}(k)+(P_{CC}(k))²
and expanding equation (6) yields:
Min P_{CC}(k) {[−(1/n_{FC}(k))*(P_{LOADS}(k)+P_{CC}(k)*n_{CC}(k))]+S*[(C(k−1))²−2*C(k−1)*P_{CC}(k)+(P_{CC}(k))²−2*(C(k−1)−P_{CC}(k))*C_{NOM}+C_{NOM}²]} (7)

The gradient of equation (7) is taken with respect to P_{CC}(k) and is set to zero to yield the optimal P_{CC}(k).
P_{CC}(k)=(n_{CC}(k)*V_{FC}^{MAX})/(2*S*V_{FC}(k))+C(k−1)−C_{NOM} (8)
Now, given the system current loads and the equation for P_{CC}(k), equation (5) can be rewritten as:
P_{FC}(k)=−(V_{FC}^{MAX}/V_{FC}(k))*(P_{LOADS}(k)+{(n_{CC}(k)*V_{FC}^{MAX})/(2*S* V_{FC}(k))+C(k−1)−C_{NOM}}*n_{CC}(k)) (9)
Equation (9) can be rewritten as an equation for I_{FC}(k) by substituting in P_{FC}(k)=V_{FC}(k)*I_{FC}(k), P_{LOADS}(k)=V_{LOADS}(k)*I_{LOADS}(k) and by noting that V_{LOADS}(k)=V_{FC}(k).
I_{FC}(k)=−(V_{FC}^{MAX}/(V_{FC}(k))²)*(V_{FC}(k)*I_{LOADS}(k)+{(n_{CC}(k)*V_{FC}^{MAX})/(2*S*V_{FC}(k))+C(k−1)−C_{NOM}}*n_{CC}(k)) (10)
Thus, two equations now exist for I_{FC}(k), i.e. equation (1) and equation (10). Setting these equations equal to each other, various methods can be used to solve for V_{FC}(k).

For system loads 14 which supply power to the bus such as regenerative brakes, the fuel cell power is set to zero and the charge carrier 16 absorbs the power.
If P_{LOADS}(k)>0 then P_{FC}(k)=0.
If the power system happens to be deigned such that it is possible for the system loads 14 to demand more power than can be supplied by the fuel cell 10, and the solved value for V_{FC}(k) is outside the limits, the fuel cell is commanded to the proper saturation point and the charge carrier 16 provides the additional power required.
If V_{FC}(k)>V_{FC}^{MAX} then V_{FC}(k)=V_{FC}^{MAX}.
If V_{FC}(k)<V_{FC}^{MIN} then V_{FC}(k)=V_{FC}^{MIN}.

The inventive control method also simultaneously takes into account durability of the charge carrier 16. In the case of the use of a battery pack, the number of the charge/discharge cycles could be increased by maintaining the charge carrier SOC at a high level and reducing the SOC window. This can be done by adjusting the parameters C_{NOM} and S. The number of cycles available vs. the SOC window for a NiMH battery pack, for example, is an exponential relationship, but can be approximated by a quadratic over a section of the curve. Then, the quadratic cost function detailed above, which is a function of the SOC window, is similar to the exponential charge/discharge cycle “cost” function, which is also a function of the SOC window.

If the fuel cell is operated in its ohmic region only, then equation (1) can be re-written into a simplified linear equation in V_{FC}(k).
I_{FC}(k)=(V_{FC}(k)−V_{O})/S_{O}

Then, the following equation can be solved for V_{FC}(k) by using the above equation and equation (10).
(V_{FC}(k))⁴−V_{O}*(V_{FC}(k))³+V_{FC}^{MAX}*I_{LOADS}(k)*S_{O}*(V_{FC}(k))²+V_{FC}^{MAX}*n_{CC}(k)*(C(k−1)−C_{NOM})*S_{O}*V_{FC}(k)+(V_{FC}*(n_{CC}(k))S_{O}/(2*S)=0 (11)

If more than one solution is found to fall within the operating region of the fuel cell, then maximum real solution should be utilized.

The control method described above has been successfully verified in simulation tests performed using a hybrid fuel cell system operating in the omhic region, and using a battery pack as the charge carrier. The initial conditions and constraints used in these tests were as follows:

$${P}_{FC}^{MAX} = 20 , 000 W$$

$${V}_{FC}^{MAX} = 400 V$$

$${V}_{FC}^{MIN} = 200 V$$

$${V}_{FC}^{MAX POWER} = 400 V$$

$${C}_{NOM} = 1 , 000$$

$$C ( 0 ) = 1 , 000$$

$$S = 1$$

$${n}_{PC} = 0.9$$

$${e}_{CC} = 0.9$$

$${V}_{O} = 400 V$$

$${S}_{O} = - 2$$

FIGS. 2-6 are waveform plots showing electrical operating parameters for the fuel cell system used in the simulation tests. FIG. 2 is a plot of the total commanded system load current as a function of time. The negative value of the current shown in FIG. 2 indicates that the loads were acting a current sink.

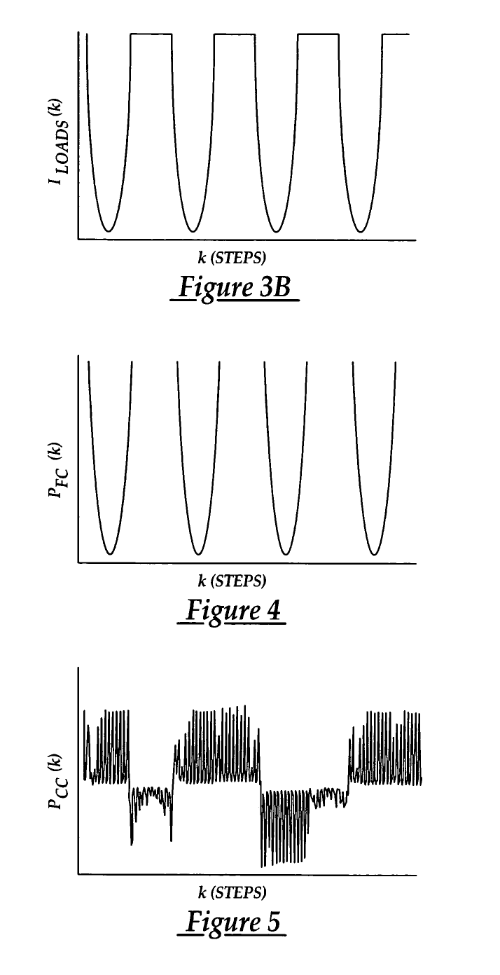

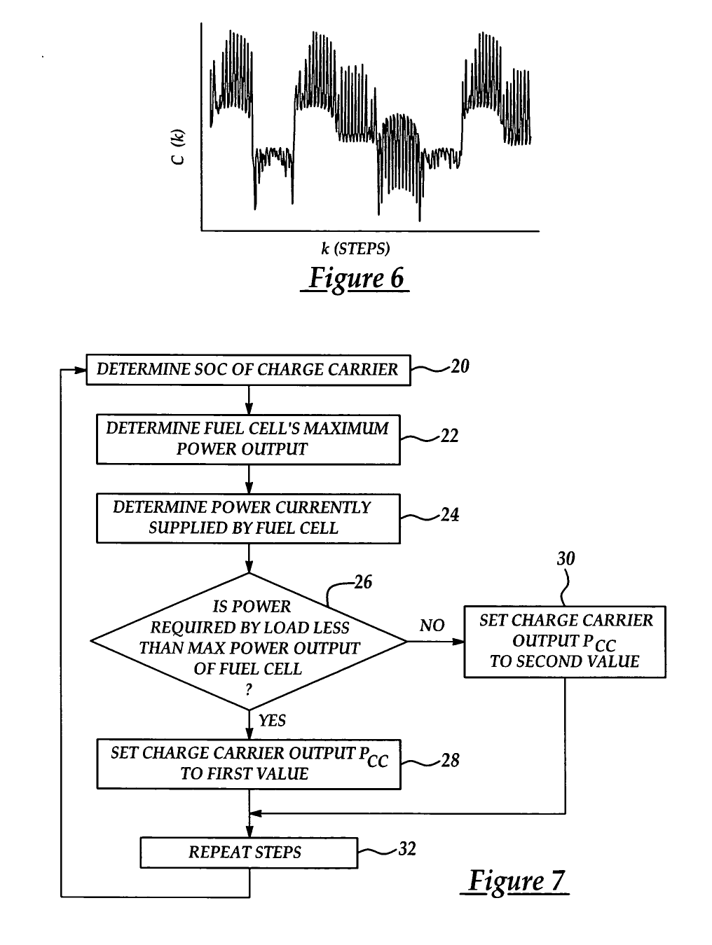

FIGS. 3a and 3b respectively show the computed values of the voltage and current output by the fuel cell, based on the calculated battery pack power. The current originates from the ohmic region of the polarization curve. FIG. 4 is a plot of the fuel cell output power, and FIG. 5 is a plot of the battery pack output power. FIG. 5 shows that the battery pack is cyclically sourcing and sinking power. FIG. 6 is a plot showing the battery pack SOC, and demonstrates that the SOC stayed within a desired band of charge, but changes over time due to changing power demands on the battery pack.

FIG. 7 is a simplified flowchart showing each of the basic steps of the inventive method. The method starts at step 20 with the determination of the current state of charge of the charge carrier 16. A determination is also made at step 22 of the maximum amount of power that can be output by the fuel cell 10. At step 24, a determination is made of the amount of power currently being output by the fuel cell 10. Steps 20-24 may be performed by direct measurement, or by inference based on other available data and information. Then at step 26, a determination is made of whether the power being currently demanded by the load 14 is less than the maximum power output of the fuel cell 10. If the answer is yes, the charge carrier output is set to a first value determined by equations previously described. But if the answer is no, then the charge carrier output is set to a second value which is also determined by the previously explained equations. As shown at 32, the method steps are then repeated, based on the using the previous SOC.

It is to be understood that the specific method and techniques which have been described are merely illustrative of one application of the principle of the invention. Numerous modifications may be made to the method as described without departing from the true spirit and scope of the invention.

1. A method of controlling the operation of hybrid power system having a fuel cell and a charge carrier for supplying power to a load, comprising the steps of:
(A) determining the state of charge of the charge carrier;
(B) setting the power output of the charge carrier to a first value if the power required by the load is less than the maximum power available to be supplied from the fuel cell; and,
(C) setting the power output of the charge carrier to a second value if the power required by the load is equal to or greater than the maximum power available to be supplied from the fuel cell.

2. The method as set forth in claim 1, including the step of determining power required by the load.

3. The method as set forth in claim 1, wherein steps (A)-(B) are repeated in a manner to maintain the state-of-charge of the charge carrier within a preselected range.

4. The method as set forth in claim 1, wherein the first value is determined based on at least the maximum voltage of the fuel cell, and the nominal state-of-charge of the fuel cell.

5. The method as set forth in claim 1, wherein the second value is determined based on the lumped system load power and the maximum power available to be supplied by the fuel cell.

6. The method as set forth in claim 4, wherein the second value is determined based on the lumped system load power and the maximum power available to be supplied by the fuel cell.

7. For use in a hybrid power system having a fuel cell and a charge carrier for supplying power to a load, a method of maintaining the state of charge of the charge carrier within a preselected range and optimizing use of the fuel cell, comprising the steps of:
(A) determining the state-of-charge of the charge carrier; and,
(B) based on the state-of-charge determined in step (A),
(i) setting the power output of the charge carrier to a first value if the power required by the load is less than the maximum power available to be supplied from the fuel cell; and,
(ii) setting the power output of the charge carrier to a second value if the power required by the load is equal to or greater than the maximum power available to be supplied from the fuel cell.

8. The method as set forth in claim 7, wherein the first value is determined based on at least the maximum voltage of the fuel cell, and the nominal state-of-charge of the fuel cell.

9. The method as set forth in claim 7, wherein the second value is determined based on the lumped system load power and the maximum power available to be supplied by the fuel cell.

10. For use in a hybrid power system having a battery pack and a fuel cell for supplying power to a load, a method of maintaining the battery pack's state-of-charge within a preselected range, comprising the steps of:
(A) monitoring the state of charge of the battery pack;
(B) determining the amount power required by the load;
(C) determining the amount of power being supplied by the fuel cell; and,
(D) setting the power output of the battery pack based on the power amounts determined in steps (B) and (C).

11. The method as set forth in claim 10, including the steps of:
(E) determining the maximum amount of power that can be supplied by the fuel cell; and,
(F) comparing the amount of power determined in step (C) with the maximum power determined in step (C).

12. The method as set forth in claim 10, wherein step (D) includes setting the power output of the battery pack to a first value if the power required by the load is less than the maximum power available to be supplied from the fuel cell, and setting the power output of the battery pack to a second value if the power required by the load is equal to or greater than the maximum power available to be supplied from the fuel cell.

13. The method as set forth in claim 12, wherein the first value is determined based on at least the maximum voltage of the fuel cell, and the nominal state-of-charge of the fuel cell.

14. The method as set forth in claim 12, wherein the second value is determined based on the lumped system load power and the maximum power available to be supplied by the fuel cell.

15. A method of reducing fuel consumption in a fuel cell hybrid electric vehicle having a charge carrier for supplying power to a load, comprising the steps of:
(A) determining the state of charge of the charge carrier;
(B) setting the power output of the charge carrier to a first value if the power required by the load is less than the maximum power available to be supplied from the fuel cell; and,
(C) setting the power output of the charge carrier to a second value if the power required by the load is equal to or greater than the maximum power available to be supplied from the fuel cell.

16. The method as set forth in claim 15, including the step of determining power required by the load.

17. The method as set forth in claim 15, wherein steps (A)-(B) are repeated in a manner to maintain the state-of-charge of the charge carrier within a preselected range.

18. The method as set forth in claim 15, wherein the first value is determined based on at least the maximum voltage of the fuel cell, and the nominal state-of-charge of the fuel cell.

19. The method as set forth in claim 15, wherein the second value is determined based on the lumped system load power and the maximum power available to be supplied by the fuel cell.
